(19) United States
(12) Patent Application Publication
(10) Pub. No.: US 2010/0134694 A1
(43) Pub. Date: Jun. 3, 2010

(54) COLOR GAMUT EXPANSION METHOD AND DISPLAY DEVICE

(75) Inventors: Masato SAKURAI, Tokyo (JP); Takehiro NAKATSUE, Kanagawa (JP)

Correspondence Address: ROBERT J. DEPKE;LEWIS T. STEADMAN, ROCKEY, DEPKE & LYONS, LLC, SUITE 5450 SEARS TOWER, CHICAGO, IL, 60606-6306, US

(73) Assignee: SONY CORPORATION, Tokyo (JP)

(21) Appl. No.: 12/607,738

(22) Filed: Oct. 28, 2009

(30) Foreign Application Priority Data
Nov. 28, 2008 (JP) 2008-305351

(51) Int. Cl. G09G 5/02; H04N 9/64

(52) U.S. Cl. 348/708; 345/590; 345/604; 348/E09.037

(57) ABSTRACT

A color gamut expansion method and a display device where the color gamut expansion method is applied are provided, realizing appropriate color reproduction compared with the prior. The color gamut expansion method includes the steps of: acquiring a subjective evaluation result signal inputted through user operation; and adjusting magnitude of chroma enhancement and magnitude of brightness contrast enhancement, of an input video signal, independently from each other, based on the subjective evaluation result signal, thereby performing a signal processing to expand a color gamut of the input video signal.

### BACKGROUND OF THE INVENTION

1. Field of the Invention

The present invention relates to a color gamut expansion method for achieving appropriate color expression, and a display device using such a color gamut expansion method.

2. Description of the Related Art

It is generally said that people prefer a slightly clear image compared with an original image as described in, for example, Fedorovskaya et al., Color Research and Application, 22, PP. 96-110, 1997, and Kang et al., ETRI Journal, 25, PP. 156-170, 2003. In addition, a wide color-gamut display having a wide color reproduction range (color gamut) is now commercialized with improvement in technology. Therefore, a color gamut of a video signal with a previous color gamut (color gamut of the sRGB standard or the BT. 709 standard defined by IEC (Internal Electro-technical Commission) is expanded and mapped, thereby colorful video display is now realizable.

In the past, several color gamut expansion methods like this (a method of expanding a color gamut of an input video signal, and mapping the expanded color gamut to a color gamut on an output side) have been reported as described in, for example, U.S. Pat. No. 5,317,426, and Kang et al., ETRI Journal, 25, PP. 156-170, 2003, Kim et al., CGIV 2004, pp. 248-253, 2004, and Muijs et al., IDW '06, 2, PP. 1429-1432, 2000. Each of them is largely based on a color gamut compression method (a method of compressing a color gamut of an input video signal, and mapping the compressed color gamut to a color gamut on an output side) used in the case of outputting an image shown on a display to a printer). This is because a color gamut generally needs to be compressed in the case since a color gamut of a printer is narrow compared with a display, and the color gamut may be expanded by using such a compression method in a reversed manner.

### SUMMARY OF THE INVENTION

Only Muijs et al. describe application of the color gamut expansion method to a wide color gamut display. However, quantitative evaluation is not made in the Muijs et al. on chroma enhancement amount and brightness contrast enhancement amount, each amount being considered to be an important factor for preferably expanding a color gamut, and therefore an optimum value (or a recommended range) of the amount is not derived.

Moreover, since the chroma enhancement amount and the brightnesss contrast enhancement amount are changed with the same value in such a previous color-gamut expansion method, appropriate color gamut expansion for a user has not been necessarily provided. Therefore, a more appropriate color-gamut expansion method is desired to be proposed for achieving more appropriate color reproduction for a user.

In view of foregoing, it is desirable to provide a color gamut expansion method and a display device, the method and the device realizing appropriate color reproduction compared with those in related art.

According to an embodiment of the invention, there is provided a color gamut expansion method including the steps of acquiring a subjective evaluation result signal inputted through user operation, and adjusting magnitude of chroma enhancement and magnitude of brightness contrast enhancement, of an input video signal, independently from each other, based on the subjective evaluation result signal, thereby performing a signal processing to expand a color gamut of the input video signal.

According to an embodiment of the invention, there is provided a display device including: an input section acquiring a subjective evaluation result signal inputted through user operation; a signal processing section adjusting magnitude of chroma enhancement and magnitude of brightness contrast enhancement, of an input video signal, independently from each other, based on the subjective evaluation result signal, thereby performing a signal processing to expand a color gamut of the input video signal; and a display section performing video display based on a video signal subjected to the signal processing by the signal processing section.

In the color gamut expansion method and the display device of an embodiment of the invention, magnitude of chroma enhancement and magnitude of brightness contrast enhancement of an input video signal are adjusted independently from each other, based on the subjective evaluation result signal, thereby performing a signal processing to expand a color gamut of the input video signal. Thus, color reproduction may be achieved in accordance with a subjective evaluation result obtained by user operation, which is preferable compared with a method in related art where the magnitude of chroma enhancement and the magnitude of brightness contrast enhancement are adjusted with the same value so that color gamut expansion is performed.

According to the color gamut expansion method and the display device of an embodiment of the invention, the magnitude of chroma enhancement and the magnitude of brightness contrast enhancement of an input video signal are adjusted independently of each other based on the subjective evaluation result signal, thereby performing a signal processing to expand a color gamut of the input video signal. Thus, this may realize appropriate color reproduction compared with a method in related art.

Other and further objects, features and advantages of the invention will appear more fully from the following description.

### BRIEF DESCRIPTION OF THE DRAWINGS

FIG. 1 is a block diagram showing a general configuration of a display device according to an embodiment of the invention.

FIG. 2 is a characteristic diagram for illustrating color gamut expansion processing performed by a signal processing section shown in FIG. 1.

FIG. 3 is a flowchart showing an example of signal processing operation performed by the signal processing section shown in FIG. 1.

FIG. 4 is a schematic diagram for illustrating pared comparison evaluation performed by a user.

FIG. 5 is a flowchart showing an example of pared comparison evaluation processing performed by a color evaluation section shown in FIG. 1.

FIG. 6 a flowchart showing another example of pared comparison evaluation processing performed by the color evaluation section shown in FIG. 1.

FIGS. 7A, and 7B are characteristic diagrams for illustrating an example of a color gamut compression method and an example of a color gamut expansion method in related art, respectively.

FIG. 8 is a characteristic diagram for illustrating color gamut expansion processing in related art according to a comparative example.

FIG. 9 is a characteristic diagram for illustrating an example of color gamut expansion processing according to the embodiment.

FIGS. 10A to 10D are schematic views for illustrating test images used in an example.

FIGS. 11A to 11D are characteristic diagrams showing an example of evaluation results using the test images shown in FIG. 10.

FIG. 12 is a characteristic diagram showing an average value of the evaluation results using the test images shown in FIGS. 11A to 11D.

### DETAILED DESCRIPTION OF THE PREFERRED EMBODIMENT

Hereinafter, a preferred embodiment of the invention will be described in detail with reference to drawings. The description is made in the following order.

1. Embodiment (example of color gamut expansion method in which chroma enhancement amount and brightness contrast enhancement amount are changed independently of each other)

2. Example (example using four test images)

3. Modification

### 1. Embodiment

### Configuration Example of Display Device

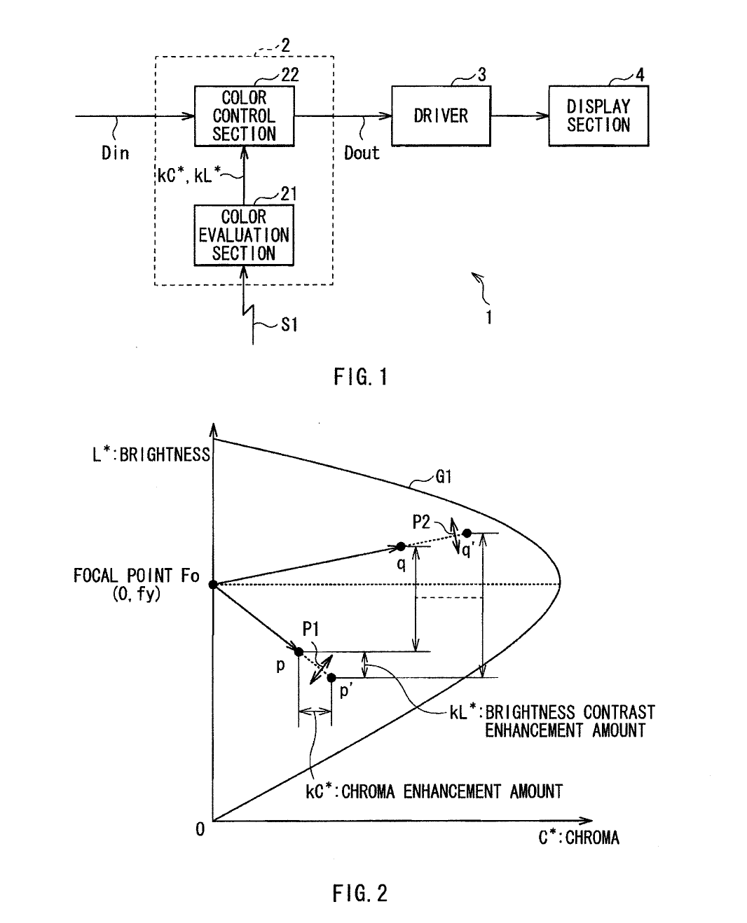

FIG. 1 shows a whole configuration of a display device (display device 1) according to an embodiment of the invention. The display device 1 performs video display based on an externally inputted, video signal Din, and has a signal processing section 2, a driver 3, and a display section 4. Since a color gamut expansion method according to the embodiment of the invention is embodied in the display device of the embodiment, the method will be described together below.

The signal processing section 2 performs signal processing of expanding a color gamut in video display to the video signal Din, and has a color evaluation section 21 and a color control section 22.

The color evaluation section 21 outputs, for example, a subjective evaluation result using paired comparison evaluation described later corresponding to a control signal S1 from a user (not shown). Specifically, the color evaluation section 21 outputs optimum chroma enhancement amount kC* and optimum brightness contrast enhancement amount kL* as such a subjective evaluation result to the color control section 22, respectively. Operation of the color evaluation section 21 will be described in detail later.

The color control section 22 performs signal processing of changing the chroma enhancement amount kC* and the brightness contrast enhancement amount kL* of the video signal Din independently of each other based on the subjective evaluation result (the optimum chroma enhancement amount kC* and the optimum brightness contrast enhancement amount kL*) supplied from the color evaluation section 21. Specifically, the color control section 22 performs signal processing of expanding a color gamut in video display by converting pixels p, q and the like of the video signal Din into pixels p′, q′ and the like, and outputs the processed signal as a video signal Dout.

A color space shown in FIG. 2 is defined by chroma C* and brightness L* of each of the video signals Din and Dout, and a horizontal axis is an axis of the chroma C*, and a vertical axis is an axis of the brightness L*. Therefore, coordinates of a pixel on the color space is expressed by (C*, L*). In the color space, a sign G1 in the figure indicates a color gamut boundary that may be expressed by the display section 4 used in video display. A point given by projecting the highest chroma point on the color gamut boundary G1 on the brightness L axis is assumed as a focal point F0 (0, fy).

More specifically, the color control section 22 performs signal processing such that a color gamut is radially expanded about the focal point F0 by using the following formulas (1) and (2). Here, coordinates of pixels p and p′ are assumed as (px, py) and (px′, py′), respectively. Operation of the color control section 22 will be described in detail later.

$$\{ \begin{matrix}{p}^{′} x = {kC}^{*} \times p x \\ {p}^{′} y = {kL}^{*} \times ( py - fy ) + fy\end{matrix} \qquad \begin{matrix}( 1 ) \\ ( 2 )\end{matrix}$$

The driver 3 performs display drive to the display section 4 based on the video signal (video signal Dout) subjected to signal processing by the signal processing section 2.

The display section 4 performs video display in accordance with display drive performed by the driver 3 based on the video signal Dout. The display section 4 includes, for example, LCD (Liquid Crystal Display), PDP (Plasma Display Panel), or an organic EL (Electro Luminescence) display.

### General Operation of Display Device

In the display device 1, the signal processing section 2 performs signal processing of expanding a color gamut in video display to the externally supplied, video signal Din, so that the video signal Dout is generated. The driver 3 performs display drive based on the video signal Dout, thereby the display section 4 performs video display.

### Operation of Signal Processing Section

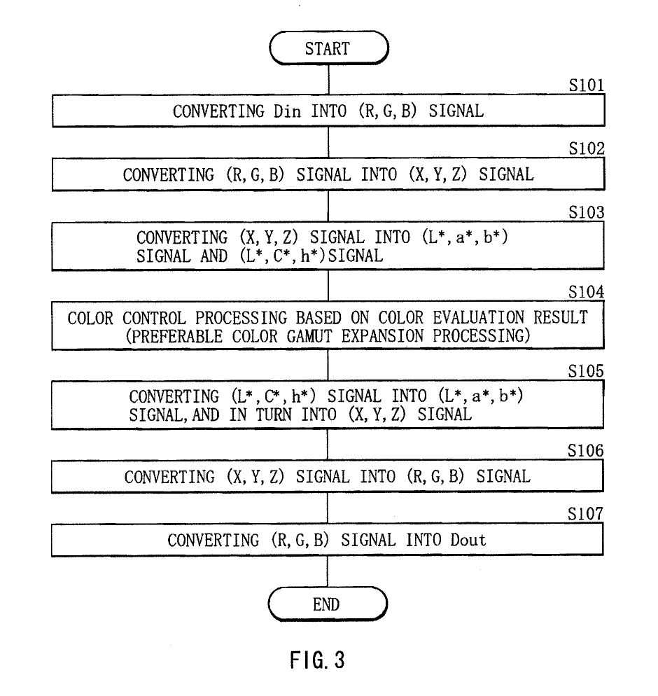

At that time, the signal processing section 2 performs, for example, the following signal processing. FIG. 3 shows, by a flowchart, an example of signal processing operation performed by the signal processing section 2.

First, the color control section 22 converts the video signal Din into a linearized (R, G, B) signal (step S101 of FIG. 3). A conversion method is different depending on a standard of the video signal Din. For example, when the video signal Din is a signal of the sRGB standard defined by IEC (IEC 61966-2-1), the signal is converted using the following formulas (3) to (11). Even in the case of a video signal of another standard, the signal is similarly converted into a linearized (R, G, B) signal through conversion in accordance with the relevant standard.

A case that Din is a signal of the sRGB standard (by IEC 61966-2-1):

$$\{ \begin{matrix}{R}_{sRGB}^{′} = {R}_{8 bit} \div 255 \\ {G}_{sRGB}^{′} = {G}_{8 bit} \div 255 \\ {B}_{sRGB}^{′} = {B}_{8 bit} \div 255\end{matrix} \qquad \begin{matrix}\begin{matrix}( 3 ) \\ ( 4 )\end{matrix} \\ ( 5 )\end{matrix}$$

A case of R′_{sRGB}, G′_{sRGB} or B′_{sRGB}≦0.04045:

$$\{ \begin{matrix}{R}_{sRGB} = {R}_{sRGB}^{′} \div 12.92 \\ {G}_{sRGB} = {G}_{sRGB}^{′} \div 12.92 \\ {B}_{sRGB} = {B}_{sRGB}^{′} \div 12.92\end{matrix} \qquad \begin{matrix}\begin{matrix}( 6 ) \\ ( 7 )\end{matrix} \\ ( 8 )\end{matrix}$$

A case of R′_{sRGB}, G′_{sRGB} or B′_{sRGB}>0.04045:

$$\{ \begin{matrix}{R}_{sRGB} = {[ ( {R}_{sRGB}^{′} + 0.055 ) / 1.055 ]}^{2.4} \\ {G}_{sRGB} = {[ ( {G}_{sRGB}^{′} + 0.055 ) / 1.055 ]}^{2.4} \\ {B}_{sRGB} = {[ ( {B}_{sRGB}^{′} + 0.055 ) / 1.055 ]}^{2.4}\end{matrix} \qquad \begin{matrix}\begin{matrix}( 9 ) \\ ( 10 )\end{matrix} \\ ( 11 )\end{matrix}$$

Next, the color control section 22 converts the linearized (R, G, B) signal into an (X, Y, Z) signal including tristimulus values X, Y and Z (step S102). Specifically, for example, when the video signal Din is a signal of the sRGB standard, the color control section 22 performs the conversion by using the following formula (12). Even if the video signal Din is a signal of another standard, the color control section 22 similarly performs the conversion according to the relevant standard so that the signal is converted into the (X, Y, Z) signal.

A case that Din is a signal of the sRGB standard (by IEC 61966-2-1):

$$[ \begin{matrix}X \\ Y \\ Z\end{matrix} ] = [ \begin{matrix}0.41240 & 0.3576 & 0.1805 \\ 0.2126 & 0.7152 & 0.0722 \\ 0.0193 & 0.1192 & 0.9505\end{matrix} ] [ \begin{matrix}{R}_{sRGB} \\ {G}_{sRGB} \\ {B}_{sRGB}\end{matrix} ] \qquad ( 12 )$$

Next, the color control section 22 converts the (X, Y, Z) signal into an (L*, a*, b*) signal and an (L*, C*, h*) signal, each signal including values in the CIE1976 L* a* b* color space (CIELAB color space) recommended in 1976 by CIE (the International Commission on Illumination) (step S103). The CIELAB color space is recommended as a uniform color space, which is a space considering uniformity with respect to perceptual color appearance of humans. Specifically, the color control section 22 converts the (X, Y, Z) signal into the (L*, a*, b*) signal and the (L*, C*, h*) signal by using the following formulas (13) to (20) and formulas (21) and (22). In the formulas, Xn, Yn and Zn are tristimulus values on a perfect reflecting diffuser, and the tristimulus values W (0.9505, 1.0000, 1.0890) of D65 are used herein (refer to formula (16)). While Yn=100 is typically assumed, Yn=1.00 is assumed here for convenience of conversion. In the formulas, L* indicates brightness, C* indicates chroma, and h indicates a hue angle, respectively.

$$\begin{matrix}XYZ -> {L}^{*} , {a}^{*} , {b}^{*} & \\ \{ \begin{matrix}{L}^{*} = 116 {( Y / {Y}_{n} )}^{1 / 3} - 16 \\ {a}^{*} = 500 \{ {( X / {X}_{n} )}^{1 / 3} - {( Y / {Y}_{n} )}^{1 / 3} \} \\ {b}^{*} = 200 \{ {( Y / {Y}_{n} )}^{1 / 3} - {( Z / {Z}_{n} )}^{1 / 3} \} \end{matrix} & \begin{matrix}\begin{matrix}( 13 ) \\ ( 14 )\end{matrix} \\ ( 15 )\end{matrix} \\ W ( X , Y , Z ) = ( 0.9505 , 1.0000 , 1.0890 ) & ( 16 )\end{matrix}$$

A case of X/Xₙ, Y/Yₙ or Z/Zₙ≦0.008856:

$$\begin{matrix}f ( X / {X}_{n} ) = 7.787 ( X / {X}_{n} ) + 16 / 116 ( \begin{matrix}the same is true for \\ f ( Y / {Y}_{n} ) or f ( Z / {Z}_{n} )\end{matrix} ) & ( 17 ) \\ \{ \begin{matrix}{L}^{*} = 116 {f ( Y / {Y}_{n} )}^{1 / 3} - 16 \\ {a}^{*} = 500 \{ {f ( X / {X}_{n} )}^{1 / 3} - {f ( Y / {Y}_{n} )}^{1 / 3} \} \\ {b}^{*} = 200 \{ {f ( Y / {Y}_{n} )}^{1 / 3} - {f ( Z / {Z}_{n} )}^{1 / 3} \} \end{matrix} & \begin{matrix}\begin{matrix}( 18 ) \\ ( 19 )\end{matrix} \\ ( 20 )\end{matrix} \\ {L}^{*} , {a}^{*} , {b}^{*} -> {L}^{*} , {C}^{*} , {h}^{*} & \\ \{ \begin{matrix}{C}^{*} = {\{ {( {a}^{*} )}^{2} + {( {b}^{*} )}^{2} \}}^{1 / 2} \\ h = {tan}^{- 1} ( {b}^{*} / {a}^{*} ) \end{matrix} & \begin{matrix}( 21 ) \\ ( 22 )\end{matrix}\end{matrix}$$

Next, the color control section 22 performs color control processing (preferable color gamut expansion processing) based on the color evaluation result given by the color evaluation section 21 (step S104). Specifically, the color control section 22 changes the chroma enhancement amount kC* and the brightness contrast enhancement amount kL* independently of each other by using the following formulas (23) and (24) based on the subjective evaluation result (the optimum chroma enhancement amount kC* and the optimum brightness contrast enhancement amount kL*) supplied from the color evaluation section 21. The formulas (23) and (24) correspond to the formulas (1) and (2), respectively. More specifically, the color control section 22 performs signal processing such that a color gamut is radially expanded about the focal point F0, for example, as shown in FIG. 2. Coordinate information of the focal point F0 is acquired by referring color gamut boundary information (information of the color gamut boundary G1) of the display section 4 at a corresponding hue angle using the hue angle h.

$$\{ \begin{matrix}{C}_{Cuspk}^{*} = {kC}^{*} \times {C}^{*} \\ {L}_{Cuspk}^{*} = {kL}^{*} \times ( {L}^{*} - {L}_{F 0}^{*} ) + {L}_{F 0}^{*}\end{matrix} \qquad \begin{matrix}( 23 ) \\ ( 24 )\end{matrix}$$

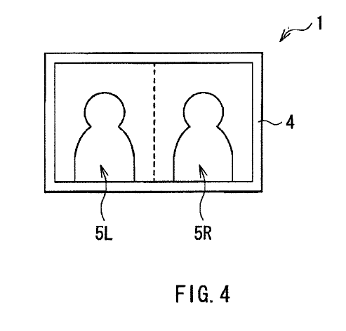

At that time, the color evaluation section 21 outputs each of the optimum chroma enhancement amount kC* and the optimum brightness contrast enhancement amount kL* as the subjective evaluation result to the color control section 22 according to a control signal S1 from a user (not shown). Such subjective evaluation is performed by a user by comparatively displaying a pair of images 5L and 5R on the display section 4, for example, as shown in FIG. 4 (subjective evaluation using pared comparison evaluation). That is, the user is allowed to perform simple subjective evaluation of the images, and the optimum chroma enhancement amount kC* and the optimum brightness contrast enhancement amount kL* are adjusted and set based on a result of the evaluation. Thus, color reproduction may be adjusted on the display section 4 in accordance with user preference.

The following two methods are specifically considered as such pared comparison evaluation processing.

(1) Among a plurality of images subjected to color enhancement by the signal processing section 2, two images are displayed in pairs on the display section 4, and a user selects preferable image. Evaluation is made on all combinations (pairs), and an image of highest winning percentage (largest number of times of selection) is determined as a preferable image.

(2) Two images of an original image and an image subjected to color enhancement by the signal processing section 2 are displayed in pairs on the display section 4. Then, a user performs chroma adjustment by a horizontal key or the like, and brightness contrast adjustment by a vertical key or the like by using a remote controller or the like, and thus determines a preferable image.

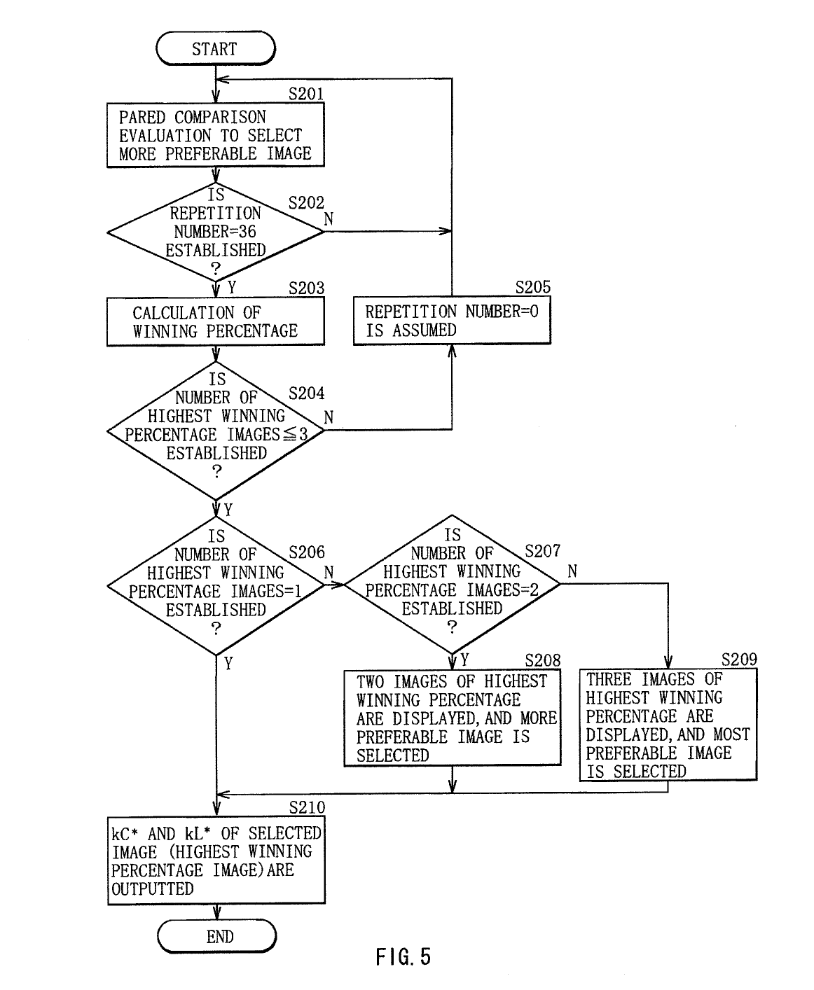

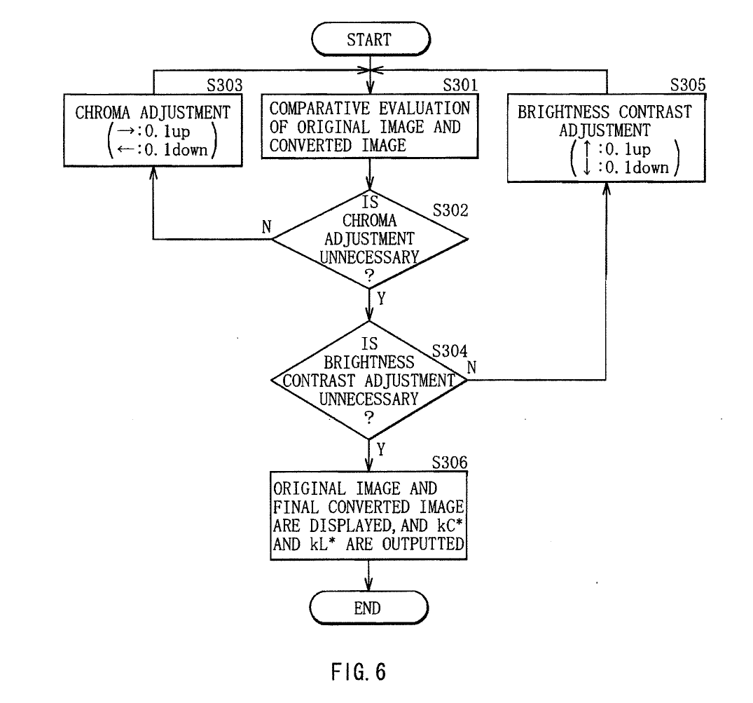

FIGS. 5 and 6 show, by flowcharts, an example of the pared comparison evaluation processing performed by the color evaluation section 21, and the figures correspond to the above-mentioned methods (1) and (2), respectively. In the processing shown in FIG. 5, for example, the chroma enhancement amount kC* and the brightness contrast enhancement amount kL* are set to 1.0, 1.2, and 1.4 times, respectively (a case of kC*=kL*=1.0 times corresponds to an original image), so that nine images are prepared in total. Therefore, number of combinations for displaying two images in pairs among the nine images is 9C2=36. On the other hand, in the processing shown in FIG. 6, for example, the chroma enhancement amount kC* and the brightness contrast enhancement amount kL* are set to 1.0, 1.1, 1.2, 1.3 and 1.4 times, respectively (a case of kC*=kL*=1.0 times corresponds to an original image), so that 25 images are prepared in total.

### Example 1 of Pared Comparison Evaluation Processing

In the pared comparison evaluation processing shown in FIG. 5 (corresponding to the method (1)), first, a user performs pared comparison evaluation to select preferable image from the pair of images 5L and 5R (step S201 of FIG. 5). Then, the color evaluation section 21 determines whether repetition number=36 is established or not (whether pared comparison evaluation is made on all combinations or not) based on the control signal S1 (step S202). If the repetition number=36 is not established (step S202: N), the processing returns to the step S201. If the repetition number=36 is established (step S202: Y), the color evaluation section 21 then performs winning percentage calculation (step S203).

The winning percentage calculation (winning percentage of preference evaluation of each converted image) may be defined by, for example, a z score (standard score), and may be obtained by the following formulas (25) and (26).

z score=(winning percentage of each converted image-average winning percentage (0.5))/standard deviation of winning percentage (25)

$$\{ \begin{matrix}winning percentage < 0.5 ⇔ z score < 0 ( negative value ) \\ winning percentage = 0.5 ⇔ z score = 0 \\ winning percentage > 0.5 ⇔ z score > 0 ( positive value )\end{matrix} \qquad ( 26 )$$

Next, the color evaluation section 21 determines whether the number of highest winning percentage images≦3 is true or not (step S204). In the case of the number of highest winning percentage images>4 (step S204: N), repetition number=0 is assumed (step S205), and the processing returns to the step S201. This is because the number of highest winning percentage images is experientially hard to increase to four or more. On the other hand, in the case of the number of highest winning percentage images≦3 (step S204: Y), the color evaluation section 21 determines whether the number of the highest winning percentage images=1 is true or not (step S206).

In the case of the number of the highest winning percentage images=1 (step S206: Y), the processing then proceeds to step S210. On the other hand, in the case of the number of highest winning percentage images≠1 (step S206: N), the color evaluation section 21 then determines whether the number=2 is true or not (step S207). In the case of the number=2 (step S207: Y), two images of the highest winning percentage are displayed on the display section 4, so that the user is allowed to select more preferable image (step S208), and then the processing proceeds to step S210. On the other hand, in the case of the number of highest winning percentage images≠2 (step S207: N), three images of the highest winning percentage are displayed on the display section 4, so that the user is allowed to select most preferable image (step S209), and then the processing proceeds to the step S210.

In the step S210, each of chroma enhancement amount kC* and brightness contrast enhancement amount kL* of the selected image (highest winning percentage image) is outputted to the color control section 22. This is the end of the pared comparison evaluation processing shown in FIG. 5.

### Example 2 of Pared Comparison Evaluation Processing

On the other hand, in the pared comparison evaluation processing shown in FIG. 6 (corresponding to the method (2)), first, a user performs pared comparison evaluation to select preferable image from the pair of images 5L and 5R (original image and converted image) (step S301 of FIG. 6). Then, the user determines whether chroma adjustment is unnecessary or not (step S302). When the user determines chroma adjustment is necessary (step S302: N), the user performs chroma adjustment using a remote controller or the like (step S303), and the processing returns to the step S301. Specifically, the user changes chroma of the converted image by using a ←→ key (←: chroma is decreased by 0.1; →: chroma is increased by 0.1). On the other hand, when the user determines chroma adjustment is unnecessary (step S302: Y), the user determines whether brightness contrast adjustment is unnecessary or not (step S304).

When the user determines brightness contrast adjustment is necessary (step S304: N), the user performs brightness contrast adjustment using a remote controller or the like (step S305), and the processing returns to the step S301. Specifically, the user changes brightness contrast of the converted image by using a ↓↑ key or the like (↓: brightness contrast is decreased by 0.1; ↑: brightness contrast is increased by 0.1). On the other hand, when the user determines brightness contrast adjustment is unnecessary (step S304: Y), the processing then proceeds to step S306. In the step S306, the original image and a final converted image are displayed on the display section 4, and each of chroma enhancement amount kC* and brightness contrast enhancement amount kL* of the final converted image is outputted to the color control section 22 (step S306). This is the end of the pared comparison evaluation processing shown in FIG. 6.

Then, processing returns to the processing of FIG. 3. After the step S104, the color control section 22 performs conversion of returning the (L*, C*, h) signal obtained in the step 104 into an (L*, a*, b*) signal. Then, the color control section 22 performs conversion of returning the (L*, a*, b*) signal into an (X, Y, Z) signal including tristimulus values X, Y and Z (step S105 of FIG. 3). Such conversion corresponds to inversion of the conversion of the step 103, and is performed using, for example, the following formulas (27) to (29) and formulas (30) to (39).

$$\begin{matrix}{L}^{*} , {C}^{*} , h -> {L}^{*} , {a}^{*} , {b}^{*} & \\ \{ \begin{matrix}{L}^{*} = {L}_{Cuspk}^{*} \\ {a}^{*} = {C}_{cuspk}^{*} \times cos ( h ) \\ {b}^{*} = {C}_{Cuspk}^{*} \times sin ( h )\end{matrix} & \begin{matrix}\begin{matrix}( 27 ) \\ ( 28 )\end{matrix} \\ ( 29 )\end{matrix} \\ {L}^{*} , {a}^{*} , {b}^{*} -> XYZ & \\ \{ \begin{matrix}X / {X}_{n} = {( \frac{{L}^{*} + 16}{116} - \frac{{a}^{*}}{500} )}^{3} \\ Y / {Y}_{n} = {( \frac{{L}^{*} + 16}{116} )}^{3} \\ Z / {Z}_{n} = {( \frac{{L}^{*} + 16}{116} - \frac{{b}^{*}}{200} )}^{3}\end{matrix} & \begin{matrix}( 30 ) \\ ( 31 ) \\ ( 32 )\end{matrix} \\ \{ \begin{matrix}X = ( X / {X}_{n} ) \times {X}_{n} \\ Y = ( Y / {Y}_{n} ) \times {Y}_{n} \\ Z = ( Z / {Z}_{n} ) \times {Z}_{n}\end{matrix} & \begin{matrix}( 33 ) \\ ( 34 ) \\ ( 35 )\end{matrix}\end{matrix}$$

A case of X/Xₙ, Y/Yₙ or Z/Zₙ≦0.008856:

$$\begin{matrix}f ( X / {X}_{n} ) = ( \begin{matrix}X / {X}_{n} - \\ 16 / 116\end{matrix} ) / 7.787 ( \begin{matrix}The same is true for \\ f ( Y / {Y}_{n} ) or f ( Z / {Z}_{n} )\end{matrix} ) & ( 36 ) \\ \{ \begin{matrix}X = f ( X / {X}_{n} ) \times {X}_{n} \\ Y = f ( Y / {Y}_{n} ) \times {Y}_{{ }_{n}} \\ Z = f ( Z / {Z}_{n} ) \times {Z}_{n}\end{matrix} & \begin{matrix}\begin{matrix}( 37 ) \\ ( 38 )\end{matrix} \\ ( 39 )\end{matrix}\end{matrix}$$

Next, the color control section 22 converts the (X, Y, Z) signal into a linearized (R, G, B) signal by using, for example, the following formulas (40) to (44).

$$[ \begin{matrix}R \\ G \\ B\end{matrix} ] = [ {M}_{Display} ] [ \begin{matrix}X \\ Y \\ Z\end{matrix} ] \qquad ( 40 )$$

Here, [M_{Display}] is a matrix satisfying the following:

$$\begin{matrix}[ \begin{matrix}100 \\ 010 \\ 001\end{matrix} ] = [ {M}_{Display} ] [ \begin{matrix}{X}_{R} {X}_{G} {X}_{B} \\ {Y}_{R} {Y}_{G} {Y}_{B} \\ {Z}_{R} {Z}_{G} {Z}_{B}\end{matrix} ] & ( 41 ) \\ [ \begin{matrix}1 \\ 1 \\ 1\end{matrix} ] = [ {M}_{Display} ] [ \begin{matrix}0.9505 \\ 1.0000 \\ 1.0890\end{matrix} ] & ( 42 )\end{matrix}$$

Furthermore, the following are assumed as tristimulus values of a display and a neutral point of the display (assumed as D₆₅), respectively.

$$\begin{matrix}\begin{matrix}\begin{matrix}{R}_{Primary} ( X , Y , Z ) = ( {X}_{R} , {Y}_{R} , {Z}_{R} ) \\ {G}_{Primary} ( X , Y , Z ) = ( {X}_{G} , {Y}_{G} , {Z}_{G} )\end{matrix} \\ {B}_{Primary} ( X , Y , Z ) = ( {X}_{B} , {Y}_{B} , {Z}_{B} )\end{matrix} \} & ( 43 ) \\ W ( X , Y , Z ) = ( 0.9505 , 1.0000 , 1.0890 ) & ( 44 )\end{matrix}$$

Next, the color control section 22 converts the linearized (R, G, B) signal into an output video signal Dout according to an input format of the display section 4 by using, for example, the following formulas (45) to (47) and formulas (48) to (50) (step S107). Specifically, when the input format of the display section 4 is, for example, RGB (8 bits, 0 to 255 gray levels), the color control section 22 quantizes the (R, G, B) signal into 8 bits by using gamma (γ) showing a gradation characteristic of the display section 4. Even in another input format, the color control section 22 converts the signal into an output video signal Dout according to the relevant format. This is the end of the signal processing operation by the signal processing section 2 as shown in FIG. 3.

A case that an input format is RGB (8 bits, 0 to 255 gray level) for a display:

$$\begin{matrix}\{ \begin{matrix}{R}^{′} = {R}^{( 1 / γ )} \\ {G}^{′} = {G}^{( 1 / γ )} \\ {B}^{′} = {B}^{( 1 / γ )}\end{matrix} & \begin{matrix}\begin{matrix}( 45 ) \\ ( 46 )\end{matrix} \\ ( 47 )\end{matrix} \\ \{ \begin{matrix}{R}_{8 bit} = Round ( 255 \times {R}^{′} ) \\ {G}_{8 bit} = Round ( 255 \times {G}^{′} ) \\ {B}_{8 bit} = Round ( 255 \times {B}^{′} )\end{matrix} & \begin{matrix}\begin{matrix}( 48 ) \\ ( 49 )\end{matrix} \\ ( 50 )\end{matrix}\end{matrix}$$

(Round indicates counting fractions over ½ as one and disregarding the rest.)

### Operation and Effects of the Embodiment

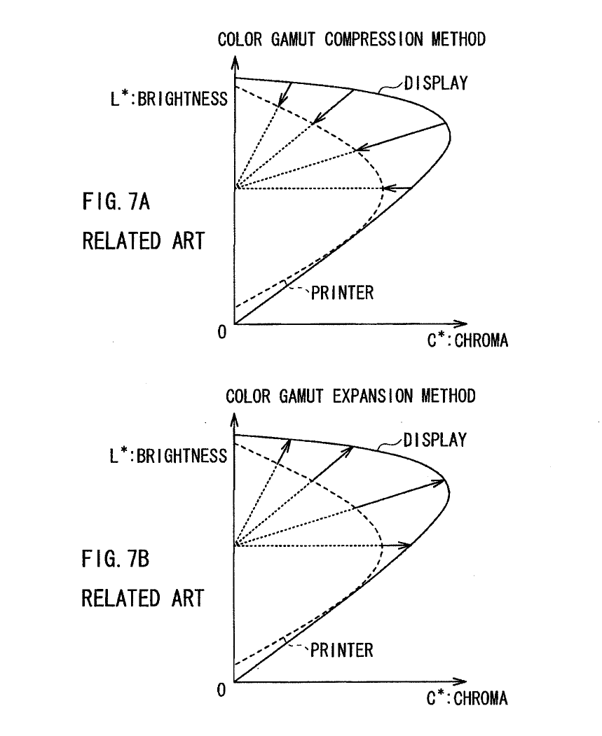

A color gamut expansion method of related art is largely based on a color gamut compression method used when an image shown on a display is outputted to a printer (refer to FIG. 7A). That is, such a color gamut compression method is reversely used to expand a color gamut, for example, as shown in FIG. 7B.

Therefore, in color gamut expansion processing of related art according to a comparative example, chroma enhancement amount kC* and brightness contrast enhancement amount kL* are changed with the same value, for example, as indicated by arrows P101 and P102 in FIG. 8, respectively. Therefore, such color gamut expansion has not been necessarily appropriate for a user.

On the other hand, in the embodiment, chroma enhancement amount kC* and brightness contrast enhancement amount kL* of the video signal Din are changed independently of each other based on a subjective evaluation result by a user as indicated by arrows P1 and P2 in FIG. 2, respectively. Thus, signal processing of expanding a color gamut in video display is performed on the video signal Din. In this case, change in color does not occur between input and output.

Therefore, color reproduction may be achieved in accordance with a subjective evaluation result by a user, which is preferable compared with the method in the past where chroma enhancement amount kC* and brightness contrast enhancement amount kL* are changed with the same value so that color gamut expansion is performed.

In the color gamut expansion method of the embodiment, signal processing is desirably performed such that chroma enhancement amount kC*=1.4 times, and brightness contrast enhancement amount kL*=1.2 times are established, for example, as shown in FIG. 9. A recommended range of each amount including such an optimum value is regarded to be desirably set as follows based on a result of an example described later.

Optimum value: kC*=1.4 times (recommended range: 1.3 to 1.4 times)

Optimum value: kL*=1.2 times (recommended range: 1.2 to 1.4 times)

As hereinbefore, signal processing is performed in the embodiment, where chroma enhancement amount kC* and brightness contrast enhancement amount kL* of the video signal Din are changed independently of each other based on a subjective evaluation result by a user, so that signal processing of expanding a color gamut in video display is performed to the video signal Din, which may realize appropriate color reproduction compared with the method in the past.

Specifically, a point given by projecting the highest chroma point, which may be expressed by the display section 4, on the brightness L* axis is assumed as the focal point F0 in the color space defined by chroma C* and brightness L* of each of the video signals Din and Dout, and signal processing is performed such that a color gamut is radially expanded. Consequently, the above advantage may be obtained.

In addition, since signal processing is performed based on a subjective evaluation result using pared comparison evaluation, color adjustment may be performed with simple preference evaluation, so that trouble in image quality adjustment may be reduced on the display section 4.

Furthermore, since a color gamut of a wide color gamut display is fully used, and thus a signal with a previous color gamut may be colorfully displayed, value added to a display may be improved.

In addition, an optimum value of chroma enhancement amount kC* and an optimum value of brightness contrast enhancement amount kL* are beforehand set, so that trouble in color adjustment by a user may be eliminated.

### 2. Example

Next, a specific example of the invention will be described.

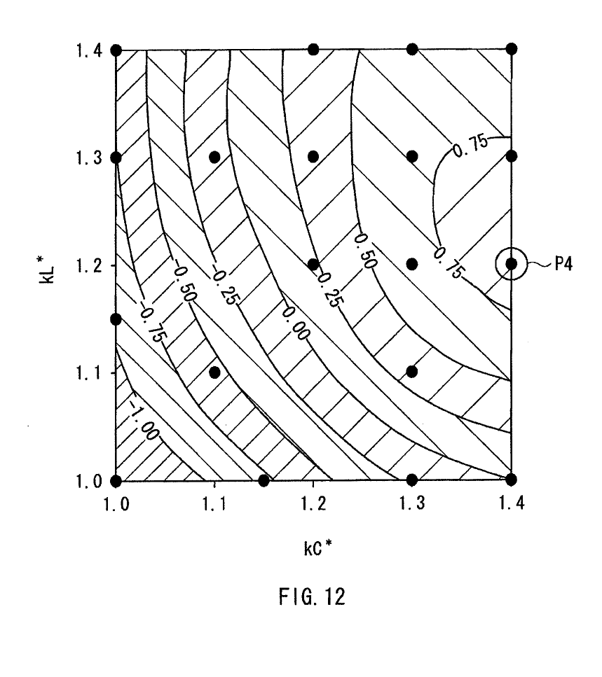

An experiment was performed at the following condition. In each test image, winning percentage of preference evaluation of each converted image was standardized with the above-mentioned Z score (standard score), and the standardized winning percentage was assumed as an evaluation value of each converted image. Enhancement amount (kC*, kL*): 1.0 to 1.4 times, 19 kinds in total each (Used combinations are as follows, which correspond to black dots in FIG. 12)

(kC*, kL*)=(1.0, 1.0), (1.15, 1.0), (1.3, 1.0), (1.4, 1.0),

(1.0, 1.15), (1.1, 1.1), (1.3, 1.1),

(1.2, 1.2), (1.3, 1.2), (1.4, 1.2),

(1.0, 1.3), (1.1, 1.3), (1.2, 1.3), (1.3, 1.3), (1.4, 1.3),

(1.0, 1.4), (1.2, 1.4), (1.3, 1.4), (1.4, 1.4)

(A case of kC*=kL*=1.0 times corresponds to an original image)

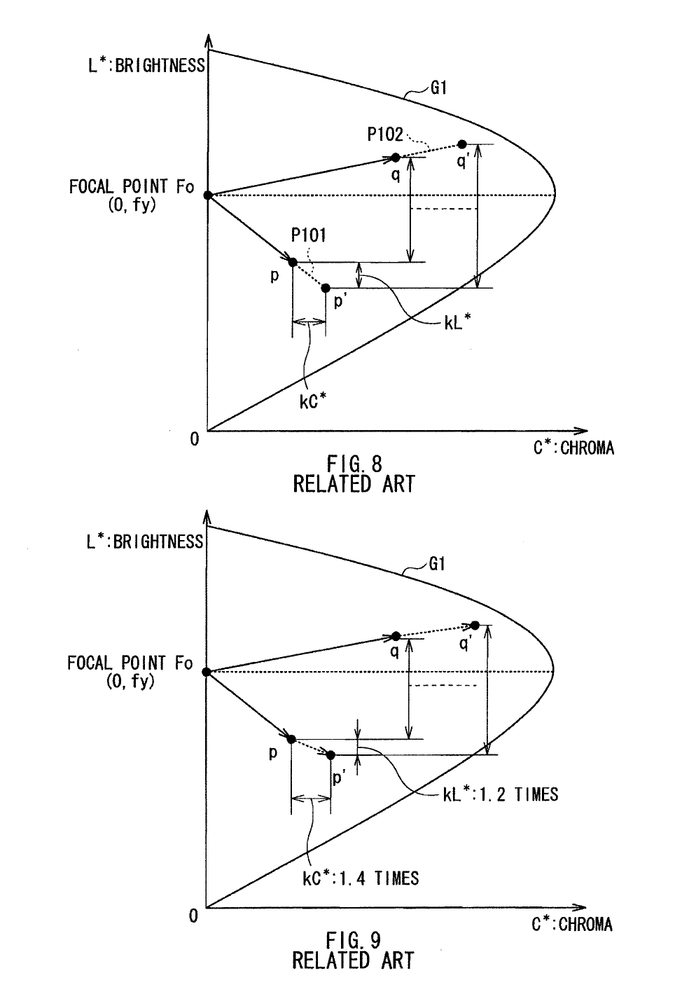

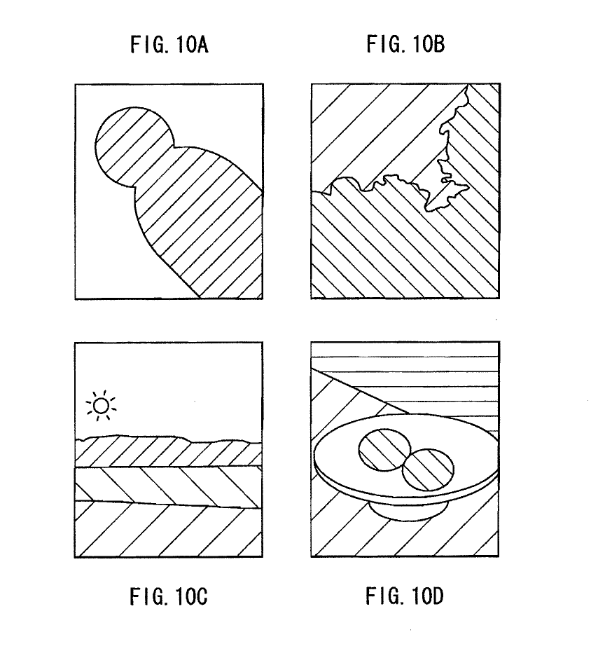

Test image: four images shown in FIGS. 10A to 10D (images of the sRGB color gamut)
Evaluation method: pared comparison method in which a subject selects a preferable image from a pair of displayed images (two images) (refer to FIG. 4)

### Subject: 11 Subjects Having Normal Color Vision

FIG. 10A shows an image of a person wearing reddish clothes. FIG. 10B shows an image of green leaves under a blue sky. FIG. 10C shows an image of a beach under sunset. FIG. 10D shows an image of reddish cakes put on a brownish dish on a tatami mat.

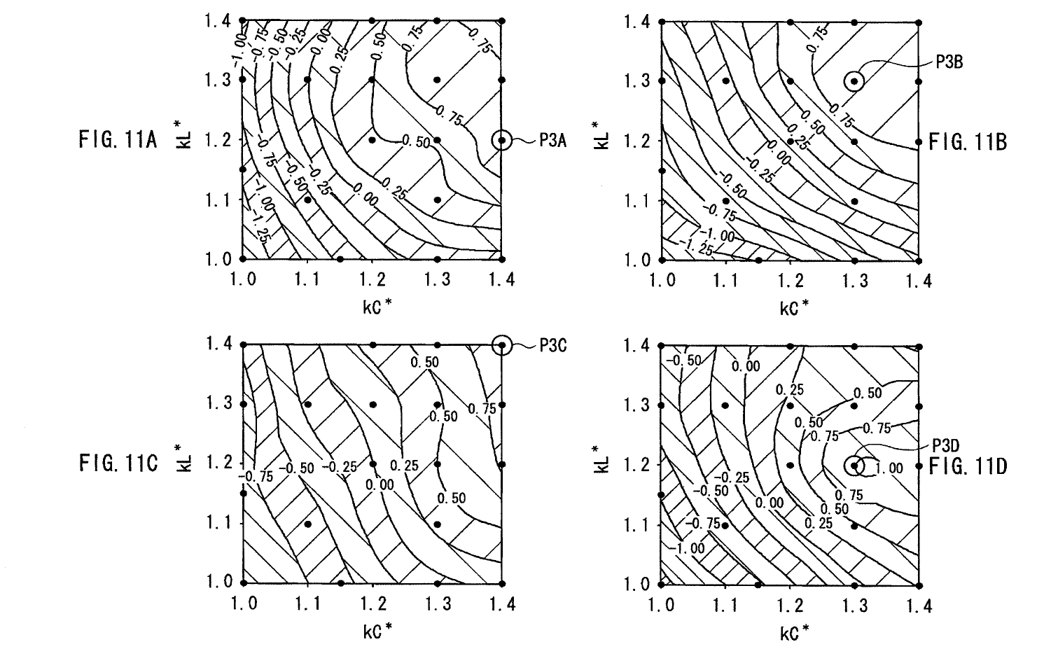

FIGS. 11A to 11D show evaluation results corresponding to the images shown in FIGS. 10A to 10D in contour drawings with z scores as numerical values on the contours, respectively. In FIGS. 11A to 11D, a horizontal axis shows kC*, a vertical axis shows kL*, and black circles show enhancement amount used in the experiment. Each of positions of black circles indicated by signs P3A to P3D in the figures corresponds to the point of the highest z score.

FIG. 12 shows an average value of the evaluation results on the four images shown in FIGS. 10A to 10D with z scores as numerical values on a contour. A position of a black circle indicated by a sign P4 in the figure corresponds to a point of a highest z score.

These results suggest that signal processing is desirably performed such that chroma enhancement amount kC*=1.4 times, and brightness contrast enhancement amount kL*=1.2 times are established as described above. A recommended range of each amount including such an optimum value is regarded to be desirably set as follows as described above.

Optimum value: kC*=1.4 times (recommended range: 1.3 to 1.4 times)

Optimum value: kL*=1.2 times (recommended range: 1.2 to 1.4 times)

### 3. Modification

Hereinbefore, the invention has been described with the embodiment and the example. However, the invention is not limited to the embodiment and the like, and may be variously altered or modified.

For example, respective values of chroma enhancement amount kC* and brightness contrast enhancement amount kL* are not limited to those described in the embodiment, and other values may be used.

In addition, a type or standard of a video signal used in the signal processing section 2 is not limited to that described in the embodiment, and a video signal of another type or standard may be used. For example, a video signal of the SRGB standard is not limitative, and a video signal of the YCbCr standard or the like may be used.

The present application contains subject matter related to that disclosed in Japanese Priority Patent Application JP 2008-305351 filed in the Japan Patent Office on Nov. 28, 2008, the entire content of which is hereby incorporated by reference.

It should be understood by those skilled in the art that various modifications, combinations, sub-combinations and alterations may occur depending on design requirements and other factors insofar as they are within the scope of the appended claims or the equivalent thereof.

What is claimed is:

1. A color gamut expansion method comprising steps of:
acquiring a subjective evaluation result signal inputted through user operation; and
adjusting magnitude of chroma enhancement and magnitude of brightness contrast enhancement, of an input video signal, independently from each other, based on the subjective evaluation result signal, thereby performing a signal processing to expand a color gamut of the input video signal.

2. The color gamut expansion method according to claim 1, wherein the signal processing is performed so that the color gamut is radially expanded from a focal point in a color space which is represented by the chroma and the brightness of the input video signal, the focal point being defined as a projected point, onto a brightness axis, of a highest chroma point which has a highest chroma to be expressed by a display section used in the video display.

3. The color gamut expansion method according to claim 1, wherein the signal processing is performed so that the magnitude of chroma enhancement is 1.4 times, and the magnitude of brightness contrast enhancement is 1.2 times.

4. The color gamut expansion method according to claim 1, wherein the subjective evaluation result signal is obtained through an evaluation by paired comparison.

5. The color gamut expansion method according to claim 1, wherein the input video signal is a video signal of the sRGB standard or the YCbCr standard defined by IEC (International Electro-technical Commission).

6. A display device, comprising:
an input section acquiring a subjective evaluation result signal inputted through user operation;
a signal processing section adjusting magnitude of chroma enhancement and magnitude of brightness contrast enhancement, of an input video signal, independently from each other, based on the subjective evaluation result signal, thereby performing a signal processing to expand a color gamut of the input video signal; and
a display section performing video display based on a video signal subjected to the signal processing by the signal processing section.
